(19) United States
(12) Patent Application Publication
(10) Pub. No.: US 2006/0216994 A1
(43) Pub. Date: Sep. 28, 2006

(54) Structure and method for connecting circuit board to surface mounting type connector and recording apparatus incorporating the structure

(75) Inventor: Takeshi Terashima, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/373,388

(22) Filed: Mar. 13, 2006

(30) Foreign Application Priority Data
Mar. 14, 2005 (JP) P2005-070426

(51) Int. Cl. H01R 13/648

(52) U.S. Cl. 439/607

(57) ABSTRACT

A circuit board have a first face and a second face which is opposite to the first face. The circuit board is formed with a through hole connecting the first face and the second face. A connector have an insulative casing body, a conductive lead portion projected from the casing body, and a connecting portion adapted to be connected with a wire harness. The connector is fixed to the circuit board such that a part of the casing body is located within the through hole, and the connecting portion is located in a side of the second face.

### BACKGROUND OF THE INVENTION

This invention relates to a structure and a method for connecting a circuit board on which electronic elements are to be mounted to a connector which is mounted on the circuit board, and more particularly to a structure of and a method for connecting a circuit board to a surface mounting type connector. The invention also relates to a recording apparatus provided with the structure for connecting the circuit board to the surface mounting type connector.

Like ordinary electronic equipments, for example, a recording apparatus, represented by an ink jet printer, employs many and various electronic elements, and these electronic elements are mounted on a plurality of printed circuit boards (hereinafter referred to as “circuit board”) each having circuits formed thereon. For electrically connecting the circuit boards together and for electrically connecting the circuit board to other electronic/electrical elements or the like, a flexible flat cable (hereinafter referred to as “FFC”) is used. The flexible flat cable is formed by a method in which a plurality of metallic conductors are arranged parallel to each other, and then are sandwiched by laminate films from both faces.

When this FFC is to be connected to the circuit board, this connection is usually carried out via a connector mounted on the circuit board. Namely, a distal end (end portion) of the FFC, at which the metallic conductors are exposed is inserted into a inlet of the connector, thereby the FFC is electrically connected to the circuit board.

One example of such connectors for connecting the circuit board to the FFC is a through-hole mounting type connector in which lead portions (conductive portions) of the connector are inserted into respective through holes formed through the circuit board. This through-hole mounting type connector is disclosed, for example, in Japanese Patent Publication No. 10-284196A. For electrical connection of the through-hole mounting type connector and electronic elements, the electronic element is mounted on a mounting face of the circuit board, and its lead portions are inserted into respective through holes in the circuit board and thereafter soldered on a reverse face of the mounting face of the circuit board. At this time, for example, a flow process is used as this soldering process. The flow process (flow soldering process) is used for soldering the electronic element. In this flow process, flux is coated on a soldering face so as to enhance solderability, and thereafter the soldering face of the circuit board is brought into contact with flowing molten solder, thereby effecting the soldering.

Another example is a surface mounting type connector in which lead portions (conductive portions) of the connector are connected respectively to conductive pads (or lands) formed on a mounting face of a circuit board. This surface mounting type connector is disclosed, for example, in Japanese Patent Publication No. 11-195869A. For electrical connection of the surface mounting type connector and electronic elements, the electronic element is mounted on a mounting face of the circuit board, and thereafter the mounting face is soldered by a reflow process. The reflow process (reflow soldering process) is used for soldering the electronic element. In this reflow process, paste-like solder is coated on the mounting face of the circuit board, and thereafter the whole of the circuit board, having the electronic elements mounted thereon, is heated within a heating furnace, thereby effecting the soldering.

In Japanese Patent Publication No. 10-284196A, the through-hole mounting type connector (particularly a connector 12 shown in FIGS. 1, 2 and 7 of this publication) is mounted on the circuit board which is a double-sided board, and further various through-hole mounting type electronic elements are mounted on both sides (faces) of this circuit board. The double-sided board is the type of circuit board in which electric circuits are formed on both sides (faces) of this circuit board. Another example of circuit boards is a single-sided board in which electric circuits are formed on only one side of the circuit board. In some cases as in the above Patent Literature of Japanese Patent Publication No. 10-284196A, the connector is mounted on the reverse face of the mounting face of the circuit board on which many elements are mounted, so that the FFC can be easily inserted into and withdrawn from the connector.

For example, when the connector is to be mounted on the reverse face of the single-sided board, the through-hole mounting type connector can be fixed to the circuit board at the reverse face side thereof, and is thus mounted on the circuit board as disclosed in Japanese Patent Publication No. 10-284196A. Namely, the conductive portions of the through-hole mounting type connector are inserted into the respective through holes from the reverse face side of the circuit board, and then the conductive portions are soldered to the respective through holes at the mounting face side of the circuit board. However, the conductive portions of the through-hole mounting type connector are soldered to the through holes by a manual soldering or by a partial-flow process using a special jig. And besides, the electronic elements are mounted on the mounting face of the single-sided board, and therefore a reflow process for soldering these electronic elements need to be carried out separately. Namely, in such a single-sided board, the two separate soldering processes, that is, the reflow soldering process for soldering the electronic elements and the soldering process for soldering the through-hole mounting type connector, need to be carried out, and therefore the process of mounting the connector, the elements, etc., on the circuit board becomes complicated, so that the production cost increases.

Japanese Patent Publication No. 11-195869A discloses a structure of combining an electronic element (connector) and a circuit board together, which is characterized in that part of the connector (surface mounting type connector) is fitted or received in a through hole, formed through the circuit board, in order to reduce a height of the connector projecting from the circuit board. However, in the surface mounting type connector described in Japanese Patent Publication No. 11-195869A, an inlet for receiving a distal end of an FFC is formed in a side face of this connector disposed at a mounting face side of the circuit board, and therefore this surface mounting type connector is different from the type of connector which is disposed at a reverse face of a circuit board.

### SUMMARY OF THE INVENTION

It is therefore an object of the invention to provide a structure of and a method for connecting a circuit board to a surface mounting type connector, in which steps of a process for mounting elements on the circuit board can be reduced, thereby reducing a production cost.

It is also an object of the invention to provide a recording apparatus provided with such a connecting structure.

In order to attain the above described object, according to the invention, there is provided a connecting structure, comprising:

a circuit board having a first face and a second face which is opposite to the first face, the circuit board being formed with a through hole connecting the first face and the second face; and

a connector having an insulative casing body, a conductive lead portion projected from the casing body, and a connecting portion adapted to be connected with a wire harness, the connector being fixed to the circuit board such that a part of the casing body is located within the through hole, and the connecting portion is located in a side of the second face.

A connecting structure may further comprise a conductive pad provided on the first face,

wherein at least a part of the lead portion is located and soldered on the conductive pad.

A connecting structure may further comprise an electronic element disposed on the first surface and electrically connected to the conductive pad.

According to the invention, the connector can be soldered by reflow soldering process. Therefore, the steps of the process for mounting the elements on the circuit board can be reduced, and the production cost can be reduced. The wire harness can be easily inserted into and withdrawn from the connecting portion of the connector. The connector is held in the through hole so that the connector can be stably fixed to the circuit board. The conductive lead portion of the connector can be positively electrically connected to the conductive pad of the circuit board, respectively.

According to the invention, there is also provided an apparatus, comprising:

a circuit board having a first face and a second face which is opposite to the first face, the circuit board being formed with a through hole connecting the first face and the second face;

a connector having an insulative casing body, a conductive lead portion projected from the casing body, and a connecting portion, the connector being fixed to the circuit board such that a part of the casing body is located within the through hole, and the connecting portion is located in a side of the second face; and

a wire harness, connected to the connecting portion.

Therefore, the apparatus which achieves the above advantageous effects can be provided.

According to the invention, there is also provided a method of manufacturing a connecting structure, comprising:

providing a circuit board having a first face on which a conductive pad is provided and a second face which is opposite to the first face, the circuit board being formed with a through hole connecting the first face and the second face;

providing a connector having an insulative casing body, a conductive lead portion projected from the casing body, and a connecting portion adapted to be connected with a wire harness;

inserting the connector into the through hole from a side of the first face so that a part of the casing body is located within the through hole and the connecting portion is located in a side of the second face; and bringing the lead portion into contact with the conductive pad.

The connecting method may further comprise soldering the lead portion to the conductive pad by reflow soldering process.

The connecting method may further comprise disposing an electronic element on the first face; and

electrically connecting the electronic element to the conductive pad by the reflow soldering process.

With this method, the connector can be soldered by the reflow soldering process, and therefore the steps of the process for mounting the elements on the circuit board can be reduced, and the production cost can be reduced.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view of a recording apparatus according to one embodiment of the present invention;

FIG. 2 is a perspective view of an internal structure of the recording apparatus showing a state that a scanner unit is removed;

FIG. 3 is section view showing a part of the recording apparatus;

FIG. 4 is a perspective view of the recording apparatus showing a state that an outer housing is removed;

FIG. 5 is a plan view of an operating board incorporated in the recording apparatus;

FIG. 6A is a plan view of a surface mounting type connector mounted on the operating board;

FIG. 6B is a side view of the surface mounting type connector;

FIG. 6C is a cross section view along the line VIC-VIC of FIG. 6B;.

FIG. 7 is a side view as seen in a direction of arrow VII of FIG. 5 showing a structure for connecting the operating board to the surface mounting type connector;

FIG. 8 is a flow chart showing a process for mounting the surface mounting type connector and electronic elements on the operating board;

FIG. 9 is a plan view showing a related-art operating board;

FIG. 10 is a side view as seen in a direction of arrow X of FIG. 9 showing a structure for connecting the related-art operating board to a related-art through-hole mounting type connector.

### DETAILED DESCRIPTION OF THE EMBODIMENTS

Embodiments of the invention will be described with reference to the accompanying drawings. More specifically, the structure for connecting the circuit board and the surface mounting type connector together which are used in an ink jet printer (which is one of recording apparatuses) will be described. The embodiment described below will not limit the scope of the appended claims, and also all of features, combined together in the embodiment, are not always essential to the solution of the problems.

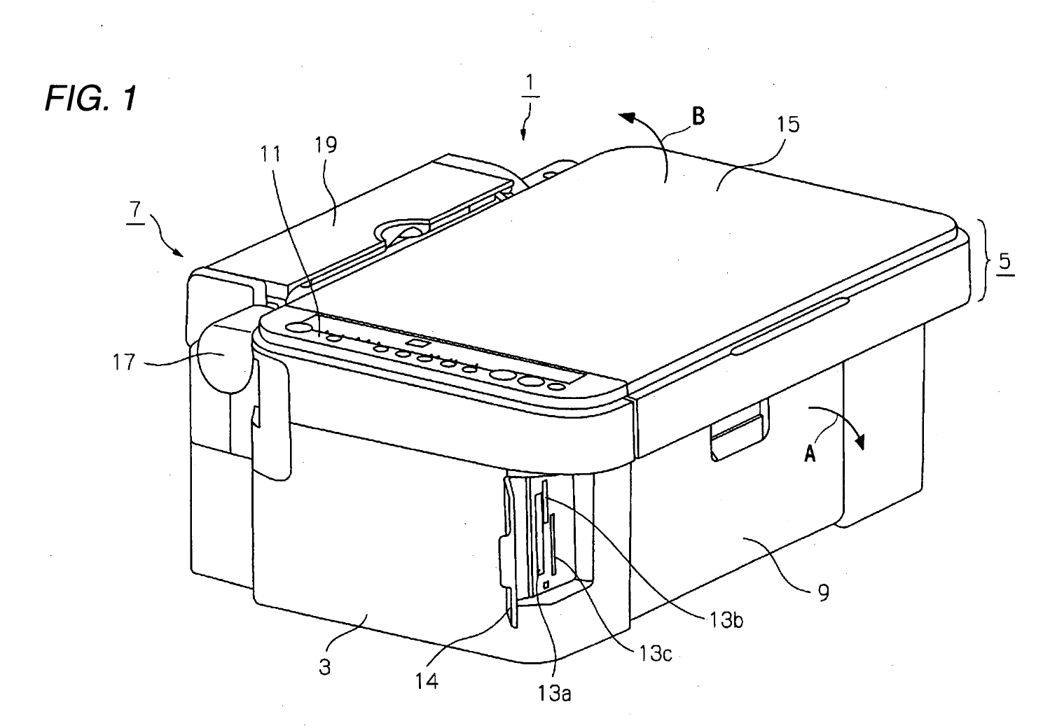

As shown in FIG. 1, a recording apparatus 1 is a hybrid machine having a scanning function and a printing function. The recording apparatus 1 comprises an apparatus body 3 operable to perform the printing function, a scanner unit 5 operable to perform the scanning function, and is mounted on an upper side of an apparatus body 3, and a feeder 7 provided at a rear side of the scanner unit 5.

The apparatus body 3 has an ejected sheet receptacle 9 for receiving ejected recording sheet is provided at the front side of this apparatus body 3. When the printing function is effected, the ejected sheet receptacle 9 is pulled forward (in a direction of arrow A in FIG. 1) to be pivoted about 90 degrees so as to receive the ejected recording sheet.

An control panel 11 is provided at a left side portion of an upper face of the recording apparatus 1. The scanning function executed by the scanning unit 5, the recording function and a function of recording a scanned image and other functions executed in the apparatus body 3, can be operated by this control panel 11.

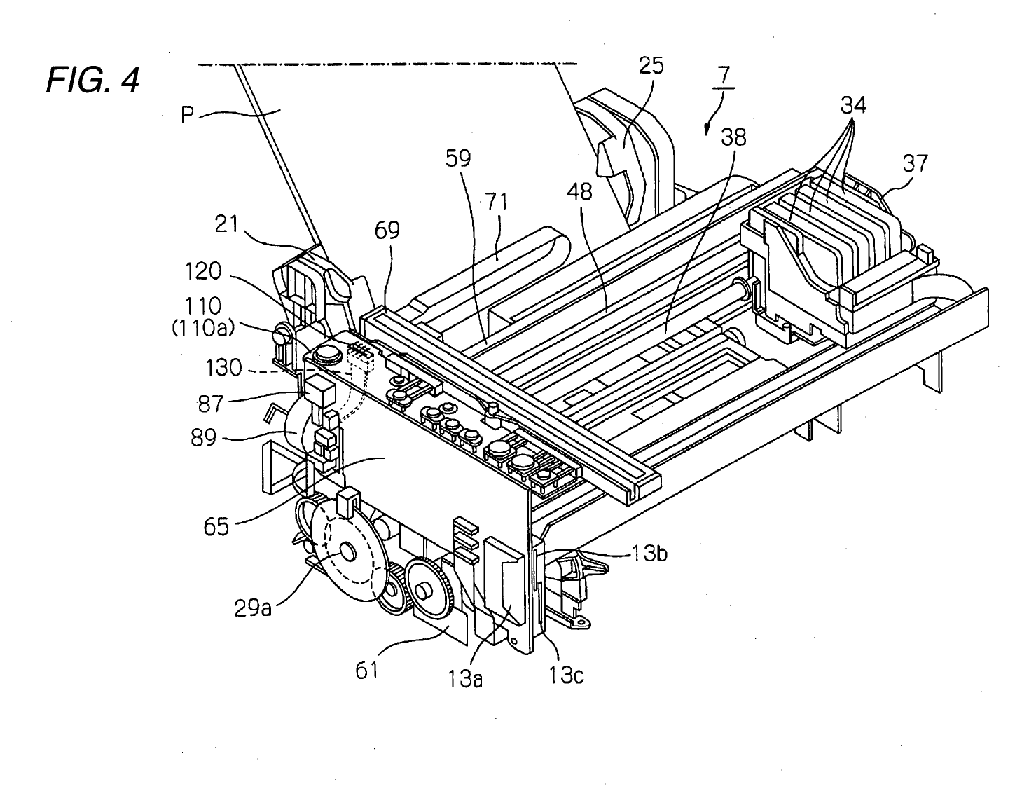

The scanner unit 5 includes a lid 15 which can be pivoted upwardly (that is, in a direction of arrow B in FIG. 1) about a pivot shaft (not shown), provided at the rear side, into an open position, and a glass table (not shown) on which a printed matter or the like to be scanned is placed is provided under the lid 15. Further, a reading head 69 (see FIG. 4) is provided under the glass support face. The whole of the scanner unit 5 can be pivoted upwardly (that is, in the direction of arrow B in FIG. 1) about a pivot shaft 17 so as to open the upper side of the apparatus body 3 so that a maintenance work for internal mechanisms (including a carriage) can be easily carried out.

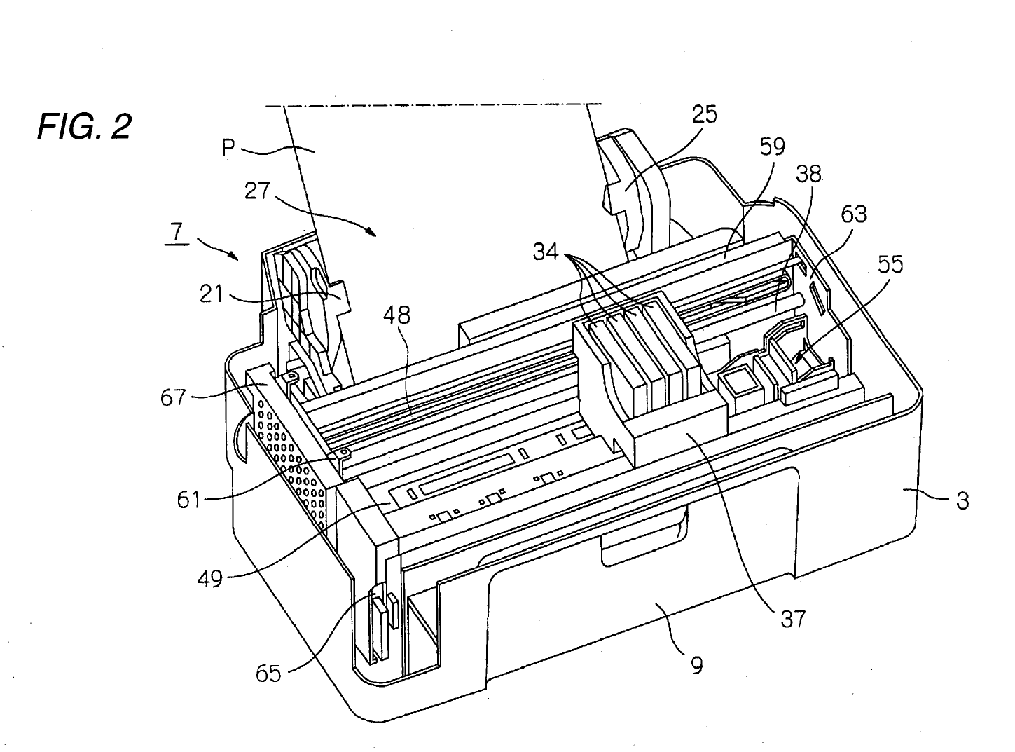

As shown in FIG. 1, the feeder 7, when not in use, is closed by a feed cover 19. When the feed cover 19 is pivoted rearwardly, the feeder 7 is opened as shown in FIG. 2, and the feed cover 19 is fixed in a condition inclined at a predetermined angle so as to serve as a medium support.

Card slots 13a, 13b and 13c are provided in a left side portion of the front face of the recording apparatus 1, and storage media (card-type semiconductor memories) which are not shown can be removably inserted into the card slots, respectively. The recording apparatus 1 can read image data directly from each of the storage media, and can form recording data so that recording can be made on the recording sheets based on these recording data.

As shown in FIG. 2, a fixed edge guide 25 for guiding side edges of recording sheets P (serving as the recording sheet) and a movable edge guide 25 for guiding side edges of the recording sheets P are provided below the feed cover 19 also serving as the medium support, and the movable edge guide 25 can be moved in accordance with the width of the recording sheet P. When the feed cover 19 is in an open condition, a feeding port 27 (see FIG. 2) is formed at the feeder 7, and the recording sheets P, received in the feeding port 27, are fed one by one from this feeding port 27 to the recording portion by a feed mechanism (not shown).

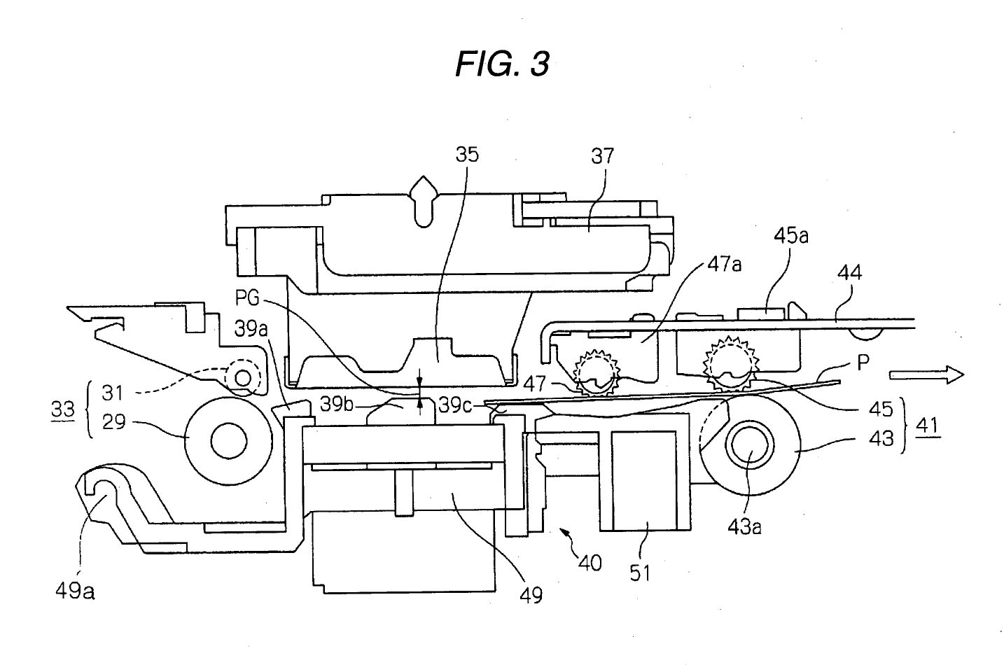

As shown in FIG. 3, the recording apparatus 1 includes an internal construction provided in the vicinities of a feeding path along which the recording sheet P is fed from a left side to a right side. The recording sheet P, fed from the feeder 7, reaches a conveyance roller 33 comprising an drive roller 29 and a follower roller 31 (which is freely rotatable). Then, the recording sheet P, while precisely fed by a drive source (not shown) during a recording process, is conveyed toward a recording head 35 located downstream of the conveyance roller 33.

The recording head 35 is supported on a carriage 37, and the carriage 37 can be reciprocally moved in a primary scanning direction perpendicular to the transporting direction of the recording sheet P. The carriage 37 is provided with independent ink cartridges 34 (see FIGS. 2 and 4) holding different color ink, respectively, and the ink can be supplied from the ink cartridges 34 to the recording head 35.

A platen unit 40 is provided in a position opposed to the recording head 35, and ribs 39a, 39b and 39c are formed on that side of the platen unit 40 opposed to the recording head 35. When recording is to be made on the recording sheet P by the recording head 35, the ribs 39a, 39b and 39c support the recording sheet P from the lower side thereof, and form a gap (hereinafter referred to as “platen gap PG”) between the recording sheet P and the recording head 35.

The medium gap PG can be suitably adjusted in accordance with the thickness of the recording sheet P. In a properly-adjusted condition of the medium gap PG, the recording sheet P smoothly passes over the ribs 39a, 39b and 39c, and high-quality recording is made on this recording sheet P. The recording sheets P, recorded by the recording head 35, are sequentially ejected by an ejecting roller 41.

The ejecting roller 41 comprises a drive roller 43, and an follower roller (spur roller) 45 which is freely rotatably supported on a “ejector frame” 44 through a holder 45a. The recording sheet P, held by the ejecting roller 41 (the drive roller 43 and the follower roller 45), is drawn and conveyed by the rotation of these rollers. A medium holding roller 47 for limiting the lifting of a trailing end of the recording sheet P is provided an upstream end portion of the ejecting frame 44 relative to the sheet transporting direction through a holder 47a, and is disposed between the recording head 35 and the ejecting roller 41. In this embodiment, the ejecting frame 44 is formed by a metal plate.

As shown in FIG. 3, the platen unit 40 comprises a first guide member 49 and a second guide member 51 which are connected together. In other words, the platen unit 40 is divided into the first guide member 49 and the second guide member 51, and the first guide member 49 can be pivoted about a pivot shaft 49a while the second guide member 51 can be pivoted about a drive roller shaft 43a. With this construction, the ribs 39a, 39b and 39c, formed on the platen unit 40, can be moved toward and away from the recording head 35 so as to adjust the medium gap PG.

Next, a base body (frame) of the recording apparatus 1 will be described with reference to FIG. 2. As shown in FIG. 2, the base body of the recording apparatus 1 comprises a main frame 59 extending in the primary scanning direction (and disposed parallel to a vertical plane), and a first side frame 61 and a second side frame 63 which are integrally formed respectively at opposite ends of the main frame 59 and are extending perpendicularly to the main frame 59.

A carriage guide shaft 38 is supported on and extend between the first and second side frames 61 and 63, and the carriage 37 is guided in the primary scanning direction by the carriage guide shaft 38. A cap unit 55 is provided in the vicinity of the second side frame 63, and is disposed beneath a path of reciprocal movement of the carriage 37. The recording head 35 (FIG. 3) is sealed by the cap unit 55, so that the clogging of nozzle orifice is prevented. When a negative pressure is applied to ink nozzles from a pump unit (not shown), the ink are ejected from the respective nozzle orifice, thereby recovering an ejectability for eliminating the clogging by the ink.

The drive roller 29 (see FIG. 3) is in the form of a shaft member extending in the primary scanning direction, and one end 29a (see FIG. 4) thereof is supported on the first side frame 61 (forming a frame face) extending perpendicularly to an axis of rotation of the drive roller 29, while the other end thereof is supported on an auxiliary frame (not shown) provided between the first side frame 61 and the second side frame 63.

The carriage 37 is fixed to a part of an endless belt 48 (see FIGS. 2 and 4) stretched by a drive pulley (not shown) provided on a carriage motor 89 (shown in FIG. 4), and a follower pulley. The carriage 37 is driven by the carriage motor 89 (see FIG. 4) to be reciprocally moved in the primary scanning direction.

Next, a positional relation between the reading head 69 which is a constituent element of the scanner unit 5, a flexible flat cable (hereinafter referred to as “FFC”) 71 connecting a main board 65 to the reading head 69, and other constituent elements of the recording apparatus 1 will be described. As shown in FIG. 4, the reading head 69 is disposed in a home position (shown in FIG. 4) in the vicinity of the first side frame 61, and can be reciprocally moved in the primary scanning direction as well as the carriage 37. The FFC 71 extends from the main board 65 (disposed in the vicinity of the home position of the reading head 69) toward the second side frame 63, and then is folded back assuming a substantially U-shape, and is connected to the reading head 69. The FFC 71 can be deformed, following the reciprocal movement of the reading head 69.

Next, the main board 65 and an operating board 110 will be described. As shown in FIG. 4, the main board 65 is disposed adjacent to an outer side of the first side frame 61 and extends substantially parallel to the first side frame 61. As shown in FIG. 2, the main board 65 covered with a shield cover 67 is mounted on the recording apparatus 1. As shown in FIG. 4, the card slots 13a, 13b and 13c are provided on the main board 65 so as to face the front side of the recording apparatus 1, and a USB slot 87 for connection to an external equipment (for example, such as a host computer) is provided on the main board 65 so as to face the rear side of the recording apparatus 1. The operating board 110, forming the control panel 11, is provided on the main board 65 so as to face the upper side of the recording apparatus 1.

As shown in FIG. 4, electronic elements (including various switches), forming the control panel 11, are surface-mounted on an operating board 110 (that is, on a mounting face 110a described later). The operating board 110 is connected to the main board 65 via a surface mounting type connector 120 and a harness 130 comprising an FFC, and electrical signals are communicated between the operating board 110 and the main board 65.

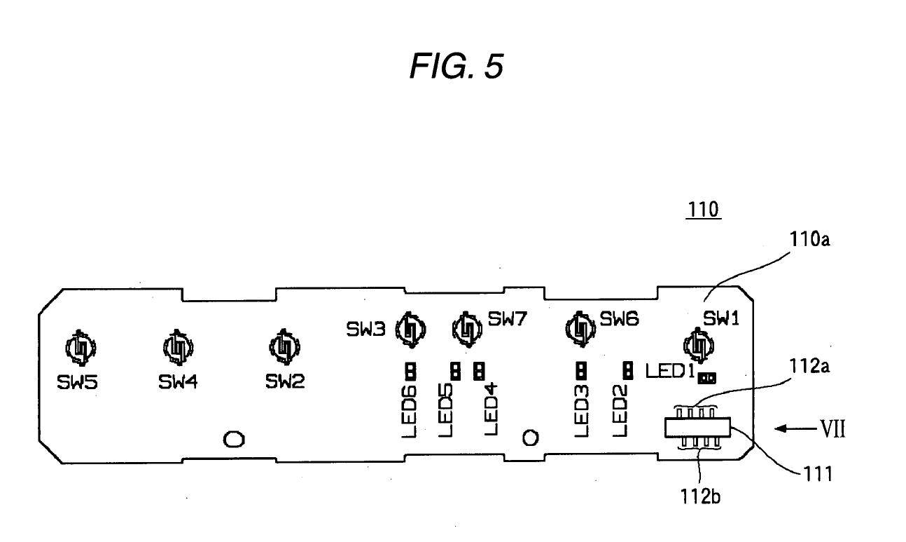

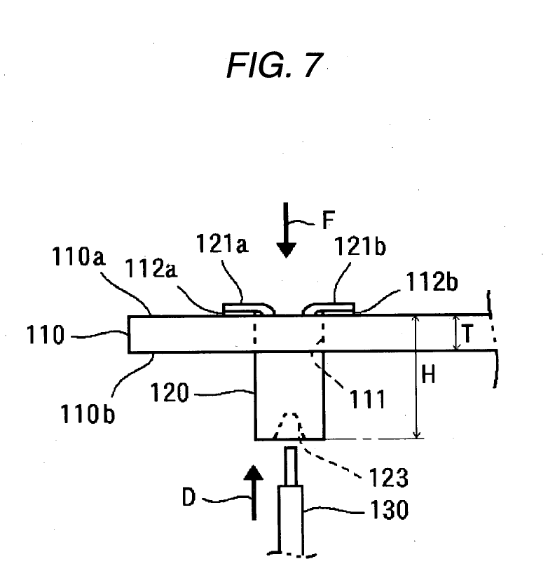

In the operating board 110 of this embodiment, the various electronic elements are surface-mounted on the mounting face 110a, and therefore in order to facilitate the insertion and withdrawal of the harness 130 and also to reduce the length of the harness 130 so as to reduce adverse effects of noises, the harness 130 is provided at a reverse face (110b) side (see FIG. 7) of the operating board 110. Namely, the surface mounting type connector 120 is mounted on the operating board 110 in such a manner that this connector 120 is fitted in a through hole 111 (see FIG. 5) formed through the operating board 110, so that the harness 130 can be inserted into and withdrawn from the connector 120 at the reverse face (110b) side of the operating board 110.

Next, the structure of the invention for connecting the circuit board (the operating board 110) to the surface mounting type connector 120 will be described in detail with reference to FIGS. 5 to 10.

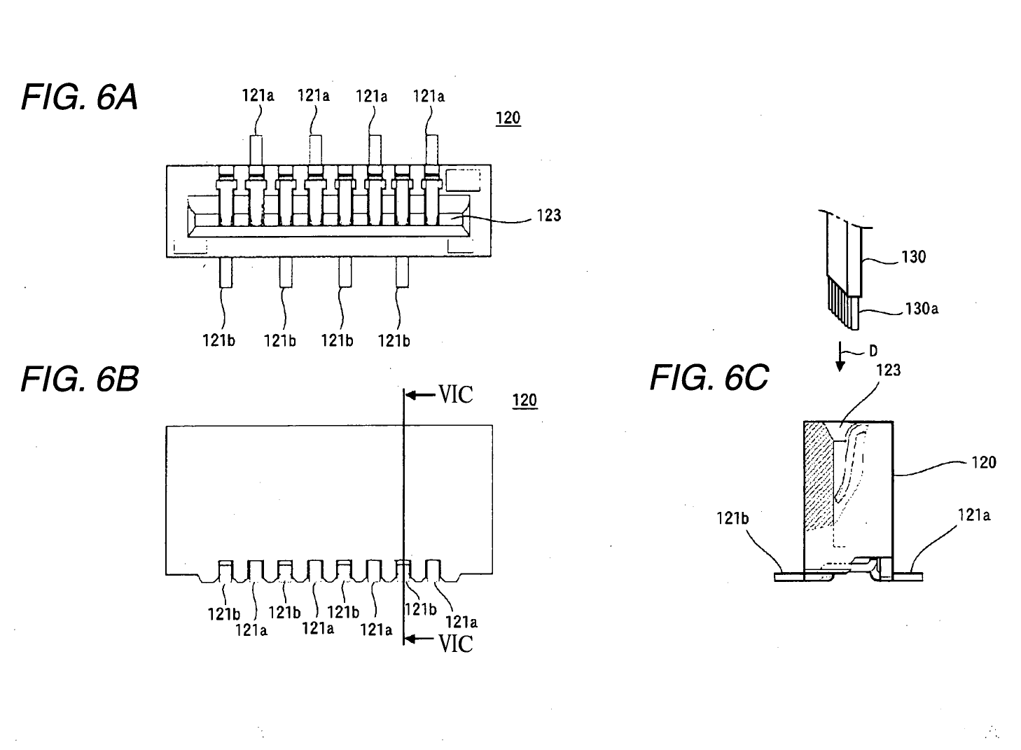

As shown in FIG. 5, the through hole 11 of a rectangular shape is formed through a lower right corner portion of the operating board 110 of this embodiment. Lands (conductive pads) 112a and 112b are formed on that portion of the operating board 110 disposed around the through hole 111 (particularly those portions disposed immediately adjacent respectively to upper and lower edges of the through hole 111 in FIG. 5), and these lands 112a and 112b are so arranged as to be held in good contact with lead portions 121a and 121b (see FIG. 6) of the surface mounting type connector 120 (hereinafter, simply referred to as “connector 120”), respectively. As shown in FIG. 4, the operating board 110 of this embodiment is a single-sided board. An upper face of the operating board 110 defines the mounting face 110a on which the electronic elements are to be surface-mounted. Electric circuits are formed only on the mounting face 110a. In FIG. 5, the electric circuits, formed by conductors, are omitted.

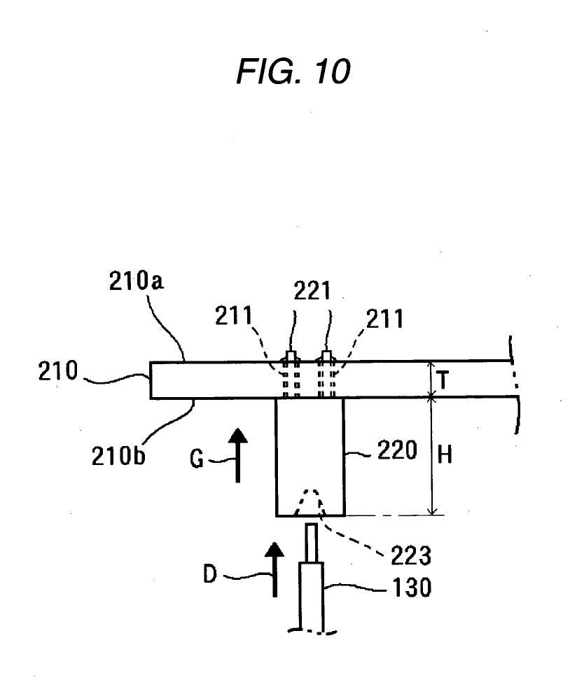

As shown in FIGS. 6A, 6B and 6C, the connector 120 has a substantially rectangular parallelepiped shape, and the lead portions 121a and 121b extend from a lower end thereof in a horizontal direction (that is, in a direction parallel to each of upper and bottom faces of the connector 120). An inlet 123 is formed in an upper portion (in FIG. 6) of the connector 120. A distal end (end portion) of the harness 130 (at which center conductors 130a are exposed) is inserted into this inlet 123 from the upper side as shown in FIG. 6C, so that the harness 130 is connected to the connector 120. In FIG. 6C, the direction inserting of the harness 130 is indicated by arrow D (This is the same with FIGS. 7 and 10.).

As shown in FIG. 7, the connector 120 is fitted into the through hole 111 of the operating board 110 from the mounting face 110a side in such a condition that the inlet 123 is faces downward, while the lead portions 121a and 121b are faces upward (The direction of fitting of the connector 120 is indicated by arrow F.). The lead portions 121a and 121b of the connector 120 are so disposed as to be opposed respectively to the lands 112a and 112b of the operating board 110, and therefore when the connector 120 is fitted into the through hole 111, the lead portions 121a and 121b of the connector 120 are positively brought into contact with the lands 112a and 112b of the operating board 111.

Normally, the connector 120 is mounted on a circuit board in such a condition (hereinafter referred to as “normal condition”) that the inlet 123 is provided on the upper side, while the lead portions 121a and 121b are provided on the lower side, and thereafter this connector 120 is surface-mounted on the circuit board by soldering by a reflow process (described later). On the other hand, in the connecting structure of the invention, the connector 120 is fitted into the through hole 111 (formed through the operating board 110) in its reversed condition (hereinafter referred to as “reversed condition”), and the connector 120 is mounted on the operating board 110. At this time, the lead portions 121a and 121b of the connector 120 can be soldered respectively to the lands 112a and 112b of the operating board 110 according to the reflow process (reflow soldering process).

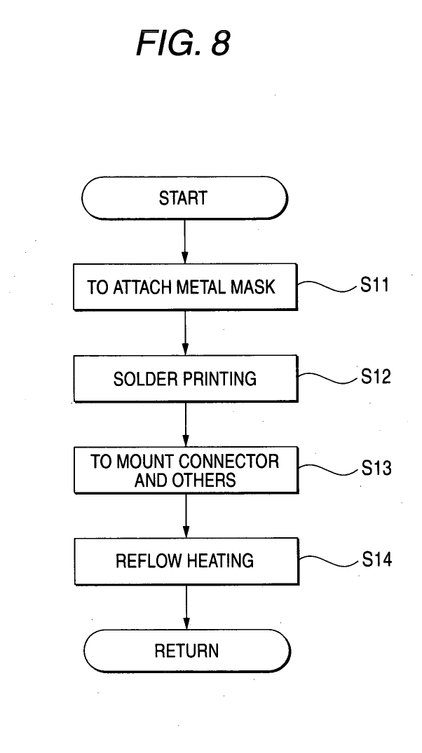

Here, the soldering process by the reflow process will be described. As described above, the reflow process (reflow soldering process) is used for soldering electronic elements including the connector 120. In this reflow process, paste-like solder is coated on the mounting face 110a of the operating board 110, and thereafter the whole of the operating board 110 is heated, thereby effecting the soldering. The process for mounting the connector 120 and the other electronic elements on the operating board 110 by the reflow process will be described with reference to FIG. 8.

First, a metal mask is put on the mounting face 110a of the operating board 110 (to which soldering is applied) to cover the same (Step S11). For example, a stainless steel mask, having holes arranged in a solder-coating pattern, is used as this metal mask.

Then, paste-like solder is coated on the mounting face 110a by a screen printing method (Step S12). Namely, in Step S11, the metal mask has been placed on the mounting face 110a to cover the same, and therefore the paste-like solder is coated on the mounting face 110a in a pattern corresponding to the solder-coating pattern of the holes of the metal mask. At this time, the paste-like solder is coated on the lands 112a and 112b.

Then, the connector 120 is fitted into the through hole 111 in the operating board 110, and is fixed to the operating board 110 as described above, and also the other electronic elements are mounted on the mounting face 110a (Step S13).

Then, the whole of the operating board 110, having the connector 120 and the electronic elements mounted thereon, is heated in a reflow facility, and as a result the paste-like solder is melted, thereby the soldering process applied to the operating board 110 is completed (Step S14). At this time, the solder, coated on the lands 112a and 112b, is melted, and then is solidified, thus the soldering of the lead portions 121a and 121b are completely soldered to the respective lands 112a and 112b.

Thus, in the structure of the invention for connecting the operating board 110 to the connector 120, the harness 130 can be inserted into and withdrawn from the connector 120 at the reverse face 110b of the operating board 110, and besides the connector 120 can be satisfactorily connected to the operating board 110 by the reflow process.

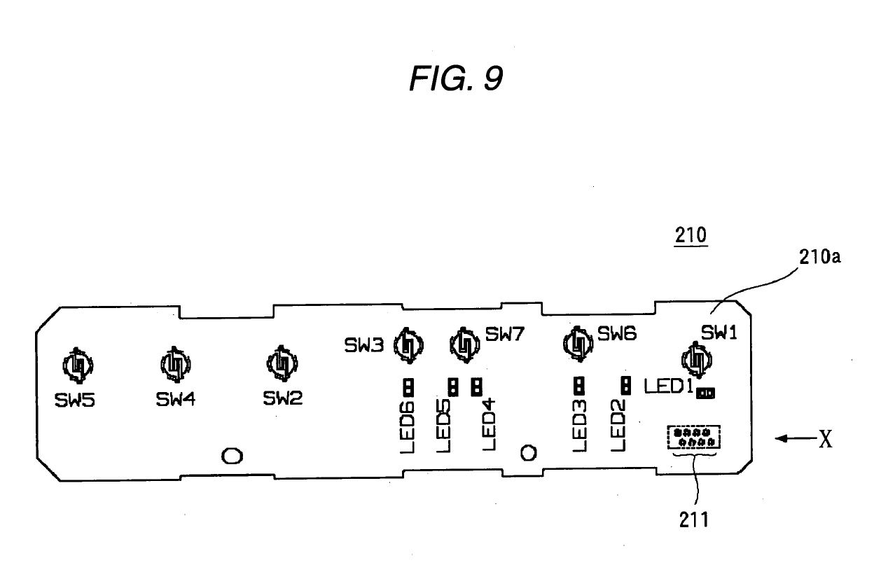

Next, the advantageous effects of the invention will be described, comparing the connecting structure of the invention with a related-art structure (comparative example) for connecting a circuit board and a connector which are shown in FIGS. 9 and 10.

As shown in FIGS. 9 and 10, a plurality of through holes 211 for the mounting of a through-hole mounting type connector 220 (hereinafter simply referred to as “connector 220″ are formed through a lower right corner portion of the operating board 210. A face of each through hole 211 is covered with a conductor connected to an electric circuit formed on the operating board 210. The operating board 210 (comparative example) is a single-sided board similar to the operating board 110 except that the plurality of through holes 211 are provided in place of the through hole 11, and the electric circuits are formed only on a mounting face 210a of the operating board 210.

As shown in FIG. 10, in the related-art connecting structure, the connector 220 is first located on a reverse face 210b of the operating board 210, and then lead portions 221 of the connector 220 are inserted respectively into the through holes 211, and the lead portions 221 are soldered respectively to the through holes 211, thereby mounting the connector 220 on the operating board 210. The connector 220 has been mounted on the reverse face 210b of the operating board 210 (which is the single-sided board in which the electric circuits are formed only on the mounting face 210a of the operating board 210 as described above)so as to enable the insertion and withdrawal of the harness 130 at the reverse face 210b of the operating board 210 while ensuring the electrical connection of the connector 220 to the electric circuits.

In this related-art connecting structure, however, it is necessary to electrically connect the lead portions 221 to the respective through holes 211 by a soldering process applied to the mounting face 210a of the operating board 210. And besides, in this soldering process, the soldering need to be carried out manually or by a flow process using a predetermined jig or the like. Therefore, the process of mounting the through-hole mounting type connector 210 and other electronic elements on the operating board 210 has been complicated. Namely, in the process of mounting the connector 220 and other electronic elements on the operating board 210, first, the electronic elements are surface-mounted on the mounting face 210a by the reflow soldering process, and then the connector 220 is fixed to the reverse face 210b, and the lead portions 221 are separately soldered to the respective through holes 211. Thus, in the related-art connecting structure, the two separate soldering processes need to be carried out, and therefore the process of mounting the through-hole mounting type connector and other electronic elements on the operating board 210 becomes complicated.

On the other hand, in the connecting structure of the invention for connecting the operating board 110 to the connector 120, the connector 120 is fitted into the through hole 111 of the operating board 110 in the direction of arrow F from the mounting face 110a, and is fixed to the operating board 110, with the inlet 123 directed to the reverse face 110b as shown in FIG. 7. With this construction, the harness 130 can be easily inserted into and withdrawn from the connector 120 at the reverse face 110b of the operating board 110. And besides, the length of the harness 130 can be reduced, and therefore adverse effects of noises on the harness 130 can be reduced. Further, the lead portions 121a and 121b of the connector 120 can be satisfactorily brought into contact with the lands 121a and 121b connected to the electric circuits formed on the operating board 110, and therefore the soldering of the lead portions 121a and 121b to the respective lands 112a and 112b can be carried out simultaneously with the soldering of the other electronic elements by the reflow soldering process. Namely, the two separate soldering processes, carried out in the related-art connecting structure, can be replaced by one reflow soldering process, and therefore the steps of the process for mounting the connector 120 and the other electronic elements can be reduced. As a result, time required for mounting the surface mounting type connector and other electronic elements on the circuit board, as well as the production cost, can be reduced.

Next, other advantages of the structure of the invention for connecting the operating board 110 to the connector 120 will be described. In FIGS. 7 and 10, the thickness of each of the operating boards 110 and 210 is denoted by T, and the height of each of the connector 120 and the connector 220 is denoted by H.

When the related-art connector 220, having the height H, is mounted on the operating board 210 as shown 20 in FIG. 10, the connector 220 projects downwardly from the reverse face 210b of the operating board 210 by an amount equal to the height H. On the other hand, in the structure of the invention for connecting the operating board 110 to the connector 120, even if the connector 110, having the same height H, is mounted on the operating board 110, the height (or amount) of projecting of the connector 110 from the reverse face 110a of the operating board 110 is (H-T), and thus the height can be reduced by an amount equal to the thickness T of the operating board 110. Namely, when a sufficient mounting space is not available on the circuit board in the height direction (the upward-downward direction), the structure of the invention is capable of reducing the projecting height of the connector.

With this construction, the inlet 123 of the connector 120 can be disposed at the reverse face 110b of the mounting face 110a of the operating board 110, and besides the connector 120 can be soldered by the reflow soldering process. As a result, the cable (harness 130) can be easily inserted into and withdrawn from the connector 120, and the steps of the process for mounting the elements on the operating board 110 can be reduced, and the production cost can be reduced.

Since the size of the through hole 111 is adjusted so that the connector 120 can be fixed to the operating board 110, the connector 120 is held in the through hole 111, and therefore the connector 120 can be stably fixed to the operating board 110.

Since the connector 120 is fitted into the through hole 111 so that the lead portions (conductive portions) 121a and 121b of the connector 120 are brought into contact respectively with the lands (conductive pads) 112a and 112b formed on the mounting face 110a, the lead portions 121a and 121b of the connector 120 can be positively electrically connected to the lands 112a and 112b of the operating board 110, respectively.

Since the connector 120 can be soldered by the reflow soldering process, the steps of the process for mounting the elements on the operating board 110 can be reduced, and the production cost can be reduced.

The present invention is not limited to the above embodiment, and can be applied to any other suitable embodiment in so far as such embodiment does not depart from the scope of the appended claims. For example, although the above embodiment of the invention is directed to the structure and method for connecting the operating board 110 to the connector 120, the invention is applicable to any circuit board, having electronic elements mounted thereon, is connected to a surface mounting type connector mounted on the circuit board.

The invention can be applied not only to the ink jet printer but also to any other suitable recording apparatus in so far as such recording apparatus is incorporating a structure for connecting a circuit board to a surface mounting type connector. Furthermore, the invention is not limited to the recording apparatus, but can be applied to other electrical and electronic equipments.

What is claimed is:

1. A connecting structure, comprising:
a circuit board having a first face and a second face which is opposite to the first face, the circuit board being formed with a through hole connecting the first face and the second face; and
a connector having an insulative casing body, a conductive lead portion projected from the casing body, and a connecting portion adapted to be connected with a wire harness, the connector being fixed to the circuit board such that a part of the casing body is located within the through hole, and the connecting portion is located in a side of the second face.

2. The connecting structure as set forth in claim 1, further comprising:
a conductive pad provided on the first face,
wherein at least a part of the lead portion is located and soldered on the conductive pad.

3. The connecting structure as set forth in claim 2, further comprising an electronic element disposed on the first surface and electrically connected to the conductive pad.

4. An apparatus, comprising:
a circuit board having a first face and a second face which is opposite to the first face, the circuit board being formed with a through hole connecting the first face and the second face;
a connector having an insulative casing body, a conductive lead portion projected from the casing body, and a connecting portion, the connector being fixed to the circuit board such that a part of the casing body is located within the through hole, and the connecting portion is located in a side of the second face; and
a wire harness, connected to the connecting portion.

5. A method of manufacturing a connecting structure, comprising:
providing a circuit board having a first face on which a conductive pad is provided and a second face which is opposite to the first face, the circuit board being formed with a through hole connecting the first face and the second face;
providing a connector having an insulative casing body, a conductive lead portion projected from the casing body, and a connecting portion adapted to be connected with a wire harness;
inserting the connector into the through hole from a side of the first face so that a part of the casing body is located within the through hole and the connecting portion is located in a side of the second face; and
bringing the lead portion into contact with the conductive pad.

6. The connecting method as set forth in claim 5, further comprising:
soldering the lead portion to the conductive pad by reflow soldering process.

7. The connecting method as set forth in claim 6, further comprising:
disposing an electronic element on the first face; and
electrically connecting the electronic element to the conductive pad by the reflow soldering process.
